(19) United States
(12) Patent Application Publication
(10) Pub. No.: US 2008/0018068 A1
(43) Pub. Date: Jan. 24, 2008

(54) Child carrier

(75) Inventor: Douglas James Bartlett, Auckland (NZ)

Correspondence Address: YOUNG & THOMPSON, 745 SOUTH 23RD STREET, 2ND FLOOR, ARLINGTON, VA, 22202, US

(73) Assignee: CABCO GROUP LIMITED, Auckland (NZ)

(21) Appl. No.: 11/878,204

(22) Filed: Jul. 23, 2007

(30) Foreign Application Priority Data
Jul. 21, 2006 (NZ) 548663

(51) Int. Cl. B62B 3/02

(52) U.S. Cl. 280/33.993; 224/159; 280/47.35

(57) ABSTRACT

A child carrier (100) having a compartment (102) for housing one or more children. The child carrier may further include an attachment assembly (112) for removably attaching the child carrier to a shopping cart, the attachment assembly including a quick release assembly (114) for releasably coupling the child carrier to the shopping cart without tools. The child carrier may include a support system (104) for supporting the compartment upon a surface (106). The support system may include a plurality of wheels (108) adapted to fully support the child carrier upon the surface such that the child carrier can be moved upon the plurality of wheels as a separate unit from the shopping cart. The child carrier (100) may include a media system (200) for providing users information and entertainment.

The invention generally relates to a child carrier for carrying a child during a shopping experience, and more specifically to a child carrier adapted to removably couple to a shopping cart.

### BACKGROUND OF THE INVENTION

In previously developed child carriers, the child carriers have been either permanently attached to a shopping cart through the use of tools or integrally formed with the shopping cart. Further, the child carriers are not self supporting, so even if removed with the assistance of tools, cannot be used separately or easily transported to and from a storage location since they do not have a wheel assembly that fully supports the child carrier. Inasmuch as the child carrier cannot be removed, or can only be removed with tools, the child carriers remain affixed only to certain shopping carts and are not readily transferable to another shopping cart. When a shopper wishes to use a shopping cart with a child carrier, the shopper must search and find the shopping carts having the child carriers, often having to go to a separate location or having to move many shopping carts out of the way to gain access to the shopping cart having the child carrier attached thereto. Further, inasmuch as the child carrier is permanently or non-removably attached to the shop cart, the child carrier accompanies the shopper to the parking lot when they go to unload their purchased goods, thus increasing the incident of theft of the child carriers since they have left the security of the store. Further still, inasmuch as the child carrier is essentially permanently or integrally formed with the shopping cart, the foot print the combined device takes up is large.

Further, previously developed shopping carts do not provide sufficient entertainment for their child passenger and/or shopper. Further still, previously developed child carriers do not provide sufficient information to the shopper regarding products and promotions available in the store and/or in vicinity of the child carrier. Additionally, previously developed child carriers do not fully protect a child during use since the child is not protected from falling objects or has openings in which the appendages of the child may extend through and be exposed to danger. Also, previously developed shopping carts do not provide the ability for remote monitoring of the functions and use of the child carrier, nor permit shoppers to select and print out coupons and promotional offers.

A few examples of previously developed child carriers having the above described problems are found in U.S. Pat. Nos. 5,848,797, 6,270,093, and 6,464,238.

Accordingly, there exists a need for a child carrier that provides one or more of the following attributes: removably attachable to a shopping cart; has a small foot print; can be moved independently of the shopping cart; that provides enhanced child and shopper entertainment, product, and/or promotion information; which is reliable; which protects a child from injury; and/or which is easily manufactured.

### OBJECT OF THE INVENTION

It is an object of the invention to provide a child carrier that ameliorates some of the disadvantages and limitations of the known art or at least provides the public with a useful choice.

### SUMMARY OF THE INVENTION

One embodiment of a child carrier formed in accordance with the present invention is provided. The child carrier may include a compartment adapted to house one or more children and an attachment assembly. The attachment assembly may be used for removably attaching the child carrier to a shopping cart. The attachment assembly may include a quick release assembly for releasably coupling and decoupling the child carrier to the shopping cart without the use of tools. The child carrier may include a support system for supporting the child carrier upon a surface, the support system including a plurality of wheels adapted to fully support the child carrier upon the surface such that the child carrier can be moved upon the plurality of wheels as a separate unit from the shopping cart when not attached to the shopping cart. The child carrier may include a media system comprising a child screen disposed in the compartment for displaying images to the one or more children when present in the compartment and an adult screen oriented to display images externally of the compartment for viewing by an adult disposed outside of the compartment.

### BRIEF DESCRIPTION OF THE DRAWINGS

The invention will now be described, by way of example only, by reference to the accompanying drawings:

FIG. 1 is a front perspective view of one embodiment of a child carrier formed in accordance with the present invention, the child carrier shown removably coupled to a shopping cart;

FIG. 2 is a front perspective view of the child carrier of FIG. 1 shown decoupled from the shopping cart;

FIG. 3 is a rear perspective view of the child carrier of FIG. 2;

FIG. 4 is a front elevation view of an entertainment center disposed within a compartment of the child carrier;

FIG. 5 is a side elevation view of the child carrier of FIG. 1;

FIG. 6 is a front elevation view of the child carrier of FIG. 1;

FIG. 7 is a top plan view of the child carrier of FIG. 1; and

FIG. 8 is a schematic diagram of a media system of the child carrier.

### DETAILED DESCRIPTION OF THE PREFERRED EMBODIMENT

The following description will describe the invention in relation to preferred embodiments of the invention, namely a child carrier. The invention is in no way limited to these preferred embodiments as they are described purely to exemplify the invention only and it is emphasized that possible variations and modifications would be readily apparent without departing from the scope of the invention.

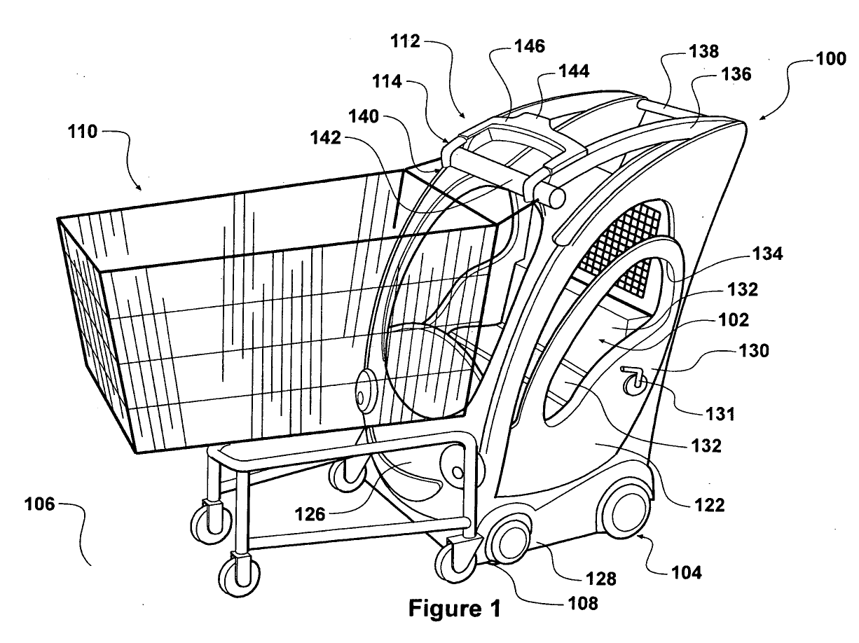

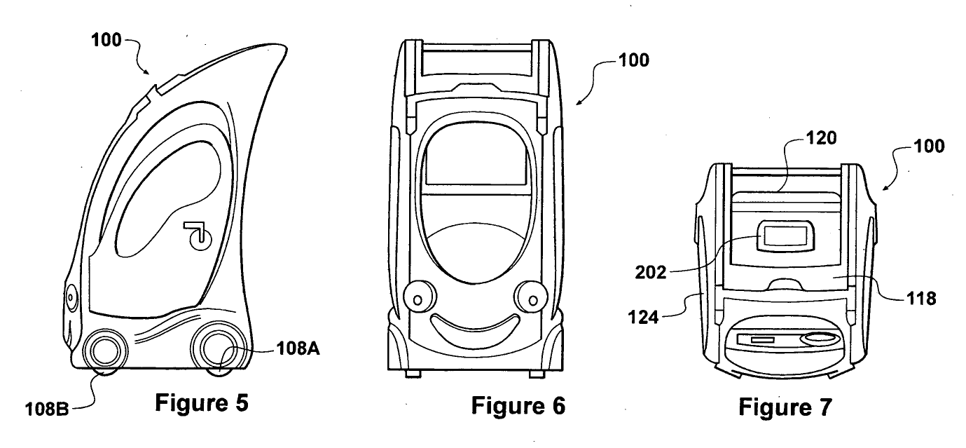

Referring to FIG. 1, one embodiment of a child carrier I 00 formed in accordance with the present invention is shown. Generally described, the child carrier 100 includes a compartment 102 for housing one or more children (not shown). The compartment 102 is fully supported by a support system 104 upon a surface 106. The support system 104 may include a plurality of wheels 108 adapted to fully support the child carrier 100 upon the surface 106 such that the child carrier 100 can be moved upon and fully supported by the plurality of wheels 108 (See FIG. 5) as a separate unit from a shopping cart 110 when the child carrier 100 is not attached to the shopping cart 110. The child carrier 100 also includes an attachment assembly 112 for removably attaching the child carrier 100 to the shopping cart 110. The attachment assembly 112 may include a quick release assembly 114 for releasably coupling and decoupling the child carrier 100 to the shopping cart 110 without the use of tools. The child carrier 100 may include a media system 200 for providing a child disposed in the compartment 102 and/or an adult using the child carrier 100 with information, such as information regarding products available in the store or in proximity to the child carrier 100, promotions available, or entertainment, such as games, music, or video.

In light of the above general description of the child carrier 100, the parts of the child carrier 100 will now be described in greater detail. The compartment 102 is preferably adapted to partially or fully enclose a child, although compartments 102 which expose a child on one or more sides are within the spirit and scope of the present invention. The compartment 102 may include a roof 118 for at least partially protecting the child from falling objects, a back 120 (See FIG. 7), a left side 122, a right side 124 (See FIG. 7), a front 126, and a floor 128. Doors 130 may form part of the left and right sides 122 and 124. The doors 130 preferably include handles 131 for locking the doors 130 in a closed position. The handles 131 are preferably only operable by an adult located externally of the compartment. A seating system 132 may be disposed in the compartment 102 for providing seating for one or more children in the compartment. In the illustrated embodiment, a bench seat is provided that is adapted to seat at least two children in a forward facing position. Preferably a plurality of windows 134 provide an occupant of the compartment 102 a view of the surrounding environment. The windows 134 in the illustrated embodiment are formed by providing open apertures in the compartment 102 which are preferably absent of glazing or other barrier. In the illustrated embodiment, windows are provided in the front, side, back panels, and the doors. In the illustrated embodiment, the compartment is of a sufficiently large volume to fully surround two kids and all of their appendages, and provide overhead protection, such that the child occupant or occupants are protected from injury and are blocked from grabbing items surrounding the child carrier.

Preferably, the child carrier 100 has a small foot print, such as less than 6,000 cm², and more preferably less than 5,000 cm², and most preferably less than 4,500 cm². Preferably the width of the child carrier 100 is less than about 80 cm, and most preferably less than 70 cm, and ideally approximately 60 cm. Preferably the length of the child carrier 100 is less than about 100 cm, most preferably less than 90 cm, and ideally less than 75 cm. Preferably the height of the child carrier 100 is greater than about 60 cm and less than about 150 cm, most preferably less than about 130 cm, and ideally less than 120 cm. The small foot print of the child carrier 100 permits the child carrier 100 to be stored in a compact manner that takes up very little floor space of the store.

Referring to FIG. 5, the support system 104 preferably includes a plurality of wheels 108, preferably three or more, and most preferably four or more. The rear wheel or wheels 108A may be fixed wheels, or more preferably, are castor type wheels adapted to be rotated about a substantially vertical axis to facilitate turning of the child carrier 100. The front wheels 108B may be fixed wheels or castor type wheels, but are preferably fixed wheels. As noted above, the support system 104 is preferably adapted to fully support the child carrier 100 such that the child carrier 100 can be freely and independently moved relative to the shopping cart 110 once detached. During use, the support system 104 preferably supports substantially the entire weight of the child carrier without reliance on the shopping cart 110 for support. The child carrier 100 is preferably only linked to the shopping cart 110 such that the motion of one along the surface 106 results in a corresponding movement along the support surface 106 of the other, and not for the purpose of supporting the weight of the child carrier 100, although such arrangements, although not preferred, are within the spirit and scope of the present invention.

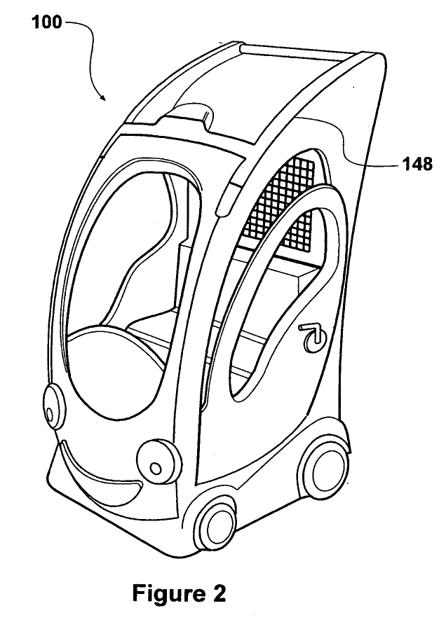

The child carrier 100 may be linked to the shopping cart 110 by the attachment assembly 112, which preferably removably attaches the child carrier 100 to the shopping cart 110. In the illustrated embodiment, the attachment assembly 112 includes a pair of arms 136 pivotally coupled to the compartment 102. Preferably, the arms 136 are pivotally coupled at a proximal end by having a handle 138 of the child carrier 100 passing through the arms 136. The arms may be pivoted between three positions; a stowed position as shown in FIG. 2, a coupled position as shown in FIG. 1, and a release position (not shown).

In the coupled position shown in FIG. 1, an attachment mechanism 140 preferably disposed at a distal end of each of the arms 136 removably couples to the shopping cart 110. Preferably, the attachment mechanism 140 may be attached and removed from the shopping cart 110 easily, without the use of tools. For instance, the attachment mechanism 140 may be a quick release mechanism for releasably coupling the child carrier to the shopping cart without tools. In the illustrated embodiment, the attachment mechanism 140 is a quick release mechanism comprising a hook that partially encircles a handle 142 of the shopping cart 110. The open portion of the hook may be oriented downward such that the weight of the arm 136 keeps the hook in contact and in position upon the handle 142, or the arm may be biased into the coupled position with a biasing assembly coupled to the arm 136 which provides additional downward force upon each of the arms to keep them engaged with the handle 142 of the shopping cart 110.

As stated above, the attachment assembly 112 may also be pivoted into the release position. In the release position, the attachment assembly 112 is simply pivoted away from the handle 142 such that the attachment mechanism 140 is no longer in engagement with the handle 142. This may be accomplished without hand tools, by simply lifting upward on the attachment assembly 112, such as by lifting upward on handle 144 disposed on cross-member 146 extending between the two arms 136 of the attachment assembly 112.

Once the attachment assembly 112 has been placed in the release position, the shopping cart 110 may be pushed away from the child carrier 100. The attachment assembly 112 may then be positioned into the stowed position. This may be accomplished by rotating the attachment assembly 112 downward such that the attachment assembly 112 is at least partially, and most preferably substantially entirely, disposed in a stowage compartment 148 of the child carrier 100 as shown in FIG. 2.

To recouple the child carrier 100 to the shopping cart 110, the shopper simply rotates the attachment assembly 112 back into the release position, such as by lifting handle 146. The shopping cart 110 is then aligned with the child carrier 100 and the attachment assembly 112 lowered into the coupled position shown in FIG. I such that the attachment assembly 112 has engaged and removably coupled to the handle 142.

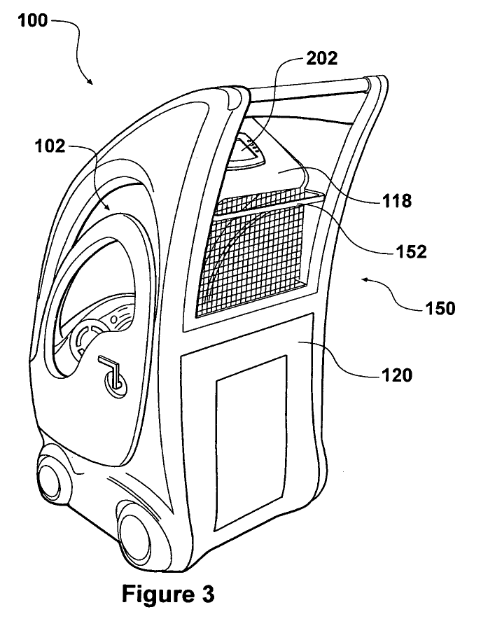

Referring to FIG. 3, the child carrier 100 may include a stowage assembly 150 having one or more goods baskets 152. In the illustrated embodiment, a single basket 152 is attached to the back 120 of the child carrier. Preferably, the basket 152 is made of a substantially translucent material or a mesh material that permits at least some vision therethrough, and is attached to a window 134 disposed in the back panel 120 such that the shopper may view occupants of the compartment 102 through the basket 152 and window 134. The basket 152 is adapted to hold one or more products or personal items, such as a purse, during the shopping process.

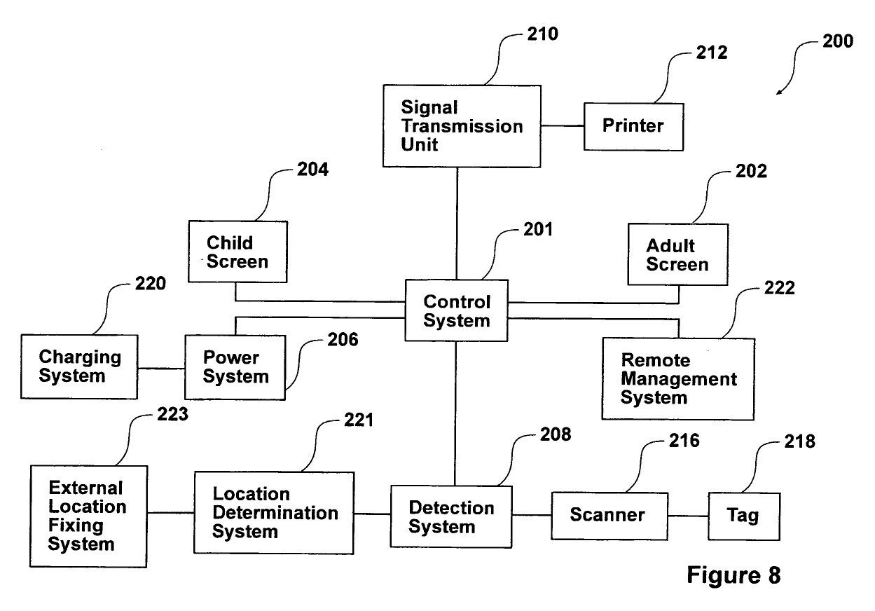

Referring to FIG. 8, the child carrier 100 may include a media system 200 for providing information and/or entertainment to either the occupant of the compartment or the shopper, or both. The media system 200 may include a control system 201, an adult screen 202, a child screen 204, a power system 206, a detection system 208, a signal transmission unit 210, a printer 212, and a remote management system 222. Turning to FIGS. 3 and 7, the adult screen 202 is preferably mounted to the compartment 102 such that images displayed on the adult screen 202 are viewable by a shopper located externally of the compartment 102. In the illustrated embodiment, the adult screen 202 is located above the occupants of the compartment 102 on the roof 118 of the compartment 102.

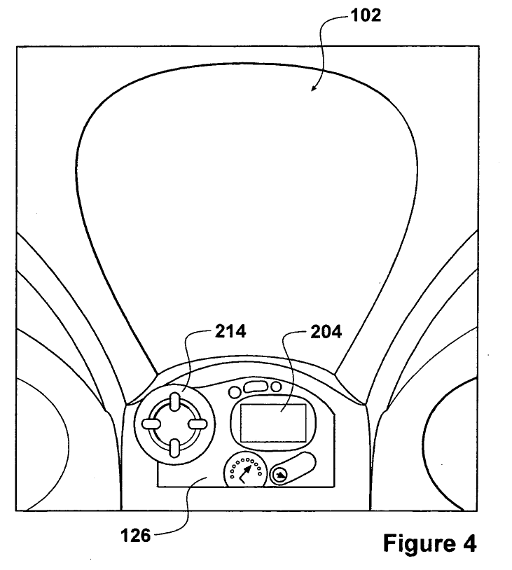

Referring to FIG. 4, the child screen 204 is preferably mounted within the compartment 102 such that images displayed on the child screen 204 are viewable by an occupant of the compartment 102. In the illustrated embodiment, the child screen 202 is located in the compartment 102 on an entertainment center board disposed on a dash board of front wall 126 of the compartment 102. Of note, the dash board also preferably includes a mock steering wheel 214 for child entertainment. The screens 202 and 204 may be any now known or to developed display device adapted to display electronic images, a few suitable examples being plasma screens, LCD screens, computer monitors, etc.

Returning to FIG. 8, the control system 201 may be adapted to display electronic images upon the adult and child screens 202 and 204. Preferably, the control system 201 is adapted to display different images of different subject matter simultaneously on the screens. For instance, the control system 201 is preferably adapted to display child appropriate images on the child screen 204, such as children movies or games, while simultaneously displaying adult oriented images on the adult screen 202, such as movies, promotions, advertisements, programs, sitcoms, still images, video images, etc. The control system 201 is also adapted to provide an associated soundtrack. The images may be sent to the control system 201 for display via an external source, such as a satellite transmitter, for immediate, instantaneous play, or may be stored in memory for later retrieval and playback. Alternatively, the images may be downloaded from a computer linked to the control system via a direct connection or wireless connection. Further, the images may be downloaded via the internet, GPRS, or WIFI system from an external source directly to a receiving station located in the store. The receiving station then transmits the images for instantaneous display or for storing by the control system 201 via RF, WIFI or similar technology.

Preferably, the control system 201 is coupled in communication with a detection system 208. The detection system 208 is adapted to detect the proximity of the child carrier 100 to a selected product or location in the store and relay this information to the control system 201. For instance, the detection system 208 is adapted to detect the child carrier's 100 presence in the vicinity of a selected product, such as COKE branded soft drinks, or in a certain location in the store where a selected product, such as soft drinks, are sold and send a trigger signal to the control system. The control system 201, upon receiving the trigger signal that a COKE product is in the vicinity of the child carrier 100, plays an advertisement or promotional offer related to the product on the adult screen 204, or less preferably, upon the child screen 202.

In one embodiment, the proximity of the child carrier 100 is determined by providing the child carrier 100 with an onboard scanner 216 that picks up a signal from a transponder or tag 218 that alerts the detection system 208 that the child carrier 100 is the vicinity of particular product (COKE) or type of product (such as soft drinks). Some suitable technologies that provide this capability are RFID, Infra-red, RF, Laser, Photoptic Light Sensor, WIFI, etc.

In another embodiment, the location of the child carrier 100 in the store is determined. The child carrier 100 includes a location determiner assembly 221 having a transmitter that emits a signal that is picked up by an external location fixing system 223 which is able to determine the location of the child carrier 100 from the signal received, and from the location information, determine the location of the child carrier 100 relative to selected products or types of products in the vicinity of the child carrier 100. A trigger signal is then sent to the detection system 208 or control system 201 by the external location fixing system 223 resulting in the control system 201 displaying media images upon the adult screen 202 related to the products in the vicinity of the child carrier 100. Some suitable technologies suitable for this embodiment are radio signal triangulation systems, such as RF and WIFI, and light triangulation systems, such as Laser and Infra-red, or other technologies, such as GRPS, and sonic (i.e. radar based technology). One suitable method of determining the carts proximity to products is discussed in U.S. Pat. No. 5,295,064, the disclosure of which is hereby expressly incorporated by reference.

The control system 201 is preferably coupled to a power system 206 for powering-the control system 201 and other components attached thereto. The power system 206 preferably includes a battery (not shown) disposed on board the child carrier 100. A charging system 220 is preferably coupled to the power system 206 for charging the battery. Preferably, the charging system 220 is an induction charging system for charging the battery by induction. For instance, the charging system 220 may include a mat that provides an induction charge to a pick up coil located within the charging system 220 of the child carrier 100, wherein the power system 206 is charged by placing the child carrier 100 over or in close proximity to the mat without having to physically connect the charging system to the power system 206 of the child carrier 100.

The child carrier 100 may further interact with a remote management system 222. The control system 201 is adapted to store key transaction and customer interaction data (a few suitable examples being the media displayed to the child and/or shopper, time of use, duration of use, goods purchased by user) and system evaluation data (a few suitable examples being equipment errors or failures). The control system 201 is adapted, on a continuous or periodic basis, or when prompted, to transmit this data to the remote management system 222 for storage. The remote management system 222 is preferably a computer system located in the store. This data is then displayed and made accessible via a system such as internet, a company network, or similar system. Preferably, the data can be sent in “live” format, hourly each day or at a preselected time sequence. Preferably, control system is adapted to conduct continuous or periodic system evaluations to determine if a system error or equipment failure has occurred or is likely to occur. Upon detecting an adverse condition, the remote management system 222 is adapted to alert an external agency of the existing or pending problem via a messaging system that may include WIFI, internet, GPRS, RF or similar. This alert may go to a cell phone, a database, or a computer system located remotely of the store, preferably to a service provider able to rectify the error or potential error.

The control system 201 may also interact with a signal transmission unit 210. The signal transmission unit 210 includes a transmitter for broadcasting a signal to a printer 212 instructing the printer to print a selected document. Preferably, a shopper is able to use the adult screen 202 to interface with the control system 201 to instruct the control system 201 to print a selected document, such as a coupon or rebate offer, at the printer 212. The printer 212 is preferably located remotely of the child carrier 100 but within the store, and may be used by all other child carriers I 00. For instance, multiple users can request different documents to be printed at a stand having the printer 212, and pick up the documents later during their shopping rounds as convenient. Alternatively, the printer 212 is located on the child carrier 100 itself.

In light of the above description of the physical structure of the child carrier 100, the operation of the child carrier 100 will now be described. During use, a shopper places a child in the compartment 102 and secures them in place using seat belts, straps, and/or by closing the doors of the child carrier 100. The shopper views the adult screen 202 and selects a type of media to be displayed upon the child screen 204 and upon the adult screen 202. The shopper removes the child carrier 100 from the charging system 220 by rolling the child carrier 100 off the induction charging mat. A sensor senses the movement of the child carrier 100 off of the induction charging mat and starts displaying the selected media on the screens 202 and 204. The media images displayed on the adult screen 202 may be interrupted while an advertisement is displayed regarding a selected product or service. This advertisement is set to play on a timed basis regardless if the child carrier is in the vicinity of the advertised product or service or not. As the child carrier 100 enters an aisle, the detection system 208 determines that a specific product is available further up the aisle. The control system 201 accordingly interrupts the media being displayed on the adult screen 202 and plays a 15 second ‘impulse buy’ purchase advertisement of that item. The control system 201 resumes displaying the media (typically an entertaining movie, sitcom, etc.) initially selected by the shopper upon completion of the ‘impulse buy’ advertisement. The shopper may request the printing of selected documents, such as coupons, rebates, or promotional offers to be printed either on a remote printer or a printer located in the store but remotely of the child carrier, such as at a print stand.

The shopper continues their shopping and enters the check out stand. The child carrier 100 detects that the shopping has finished and sends instructions to the shopper and asks the occupants of the compartment 102 to exit the compartment 102. The control system 201 stops displaying the media on the screens 202 and 204. The shopper returns the child carrier 100 over the induction charging mat of the charging system 220 and decouples the child carrier 100 from the shopping cart 110. The shopping cart 110 is taken to the parking lot and the purchased goods removed.

The control system 201 in coordination with the remote management system 222 monitors the use of the child carrier 100 to collect use data, and also monitors the child carrier 100 for operating errors and failures. Preferably this information is transmitted to a computer system located remotely of the store for monitoring. Preferably, if a scan of the systems of the child carrier 100 reveals a problem, an instantaneous alert is sent to service personnel located remotely of the store requesting corrective action.

Advantages

A child carrier formed in accordance with the present invention provides many advantages over previously developed child carriers, a few examples of these advantages are recited below:

a) removable from a standard shopping cart such that the child carrier can be stored separately, takes up less space, and/or permits the shopping cart to leave the store while the high value item of the child carrier remains secure in the store;

b) a small foot print such that the child carrier can be stored in a smaller space;

c) provides separate screens for the parent and child;

d) the child carrier can be removed from the shopping cart without the use of hand tools and connected back thereto, again without the use of hand tools;

e) can provide targeted advertisements of products or services provided in the vicinity of the child carrier;

f) can be charged without requiring connection of an electrical chord to the child carrier;

g) can monitor system functions and customer use and provide alerts and information remotely of the store;

h) self-contained unit that has its own wheel support such that the child carrier can be moved easily and independently of a shopping cart;

i) can instruct customer selected coupons and promotional offers to be printed at a remote location or onboard the child carrier;

j) provides a safe enclosure that substantially encases a child to protect the child from injury; and

k) is able to couple to a standard shopping cart such that the standard shopping cart can be used in its normal way by a shopper without a child and also be easily converted to carry a child through coupling the child carrier to the standard shopping cart.

Variations

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A child carrier comprising:
(a) a compartment adapted to house one or more children;
(b) an attachment assembly for removably attaching the child carrier to a shopping cart, the attachment assembly including a quick release assembly for releasably coupling and decoupling the child carrier to the shopping cart without the use of tools;
(c) a support system for supporting the child carrier upon a surface, the support system including a plurality of wheels adapted to fully support the child carrier upon the surface such that the child carrier can be moved upon the plurality of wheels as a separate unit from the shopping cart when not attached to the shopping cart; and
(d) a media system comprising a child screen disposed in the compartment for displaying images to the one or more children when occupying the compartment and an adult screen oriented to display images externally of the compartment for viewing by an adult disposed outside of the compartment.

2. The child carrier of claim 1, wherein the attachment assembly is pivotally coupled to the child carrier, the attachment assembly adapted to pivot from a coupled position in which the quick release assembly engages the shopping cart to couple the child carrier to the shopping cart to a release position in which the quick release assembly is lifted away and disengaged from the shopping cart.

3. The child carrier of claim 2, wherein the quick release assembly includes a hook adapted to hook a portion of the shopping cart.

4. The child carrier of claim 3, wherein the portion of the shopping cart hooked by the hook is a handle of the shopping cart.

5. The child carrier of claim 2, wherein the attachment assembly is further adapted to pivot into a stored position in which at least a majority of the attachment assembly is disposed within a stowage recess in the child carrier.

6. The child carrier of claim 1, wherein the shopping cart is capable of use without the child carrier and has a rear handle and a basket mounted to a frame supported by a plurality of wheels, and wherein the attachment assembly is adapted to removably couple to the rear handle of the shopping cart.

7. A child carrier comprising:
(a) a compartment adapted to house one or more children;
(b) a media system comprising a child screen disposed in the compartment for displaying images to the one or more children when present in the compartment and an adult screen oriented to display images externally of the compartment for viewing by an adult disposed outside of the compartment;
(c) a support system for supporting the child carrier upon a surface, the support system including a plurality of wheels; and
(d) an attachment assembly for removably attaching the child carrier to a shopping cart without use of tools.

8. The child carrier of claim 7, wherein the media system is adapted to display a first set of images upon the child screen and simultaneously display a second set of different images on the adult screen.

9. The child carrier of claim 7, further comprising a control system comprising a detection system for detecting the child carrier's proximity to a selected product or location in a store and a media playing device adapted to play a selected advertisement related to the selected product or location in the store on the adult screen when the detection system determines that the child carrier is in proximity to the selected product or location in the store.

10. The child carrier of claim 7 further comprising a signal transmission unit coupled to the compartment for transmitting requests for printed material to a printing device located remotely of the child carrier.

11. The child carrier of claim 7, wherein the attachment assembly includes at least one arm pivotally coupled to the child carrier at a pivot point, the arm having a quick release assembly spaced from the pivot point for removably gripping the shopping cart.

12. The child carrier of claim 1, wherein the quick release assembly includes a hook adapted to hook a push handle of the shopping cart.

13. The child carrier of claim 11, further comprising a handle attached to the child carrier permitting a user to move the child carrier by pushing or pulling on the handle, wherein the arm is pivotally coupled to the handle.

14. The child carrier of claim 11, wherein the child carrier includes an arm recess, wherein the arm recess is sized and shaped to receive the arm when the arm is not coupled to the shopping cart.

15. The child carrier of claim 7, wherein the plurality of wheels are adapted to fully support the child carrier upon the surface such that the child carrier can be moved as a separate unit from the shopping cart fully supported by the plurality of wheels.

16. The child carrier of claim 7, wherein the compartment is adapted to house at least two children within an interior space of the compartment, the compartment having a seat assembly for supporting the at least two children in a forward facing orientation, and wherein the compartment includes a roof disposed above the at least two children.

17. The child carrier of claim 16, wherein the adult screen is attached to the roof.

18. The child carrier of claim 7, further comprising a basket attached to the child carrier, the basket adapted to hold one or more items to be purchased.

19. The child carrier of claim 7, wherein the compartment defines an interior space adapted to substantially or entirely enclose the one or more children within the interior space.

20. The child carrier of claim 7, further including an error identification system for automatically scanning the media system for errors and for automatically broadcasting an electronic error signal for transmission remotely of a store in which the child carrier is in if a problem is identified during scanning.

21. The child carrier of claim 7, further including a charging system for charging a battery coupled to the media system for powering the media system, the charging system including an induction coil for generating electrical current to charge the battery without a direct physical connection to an electrical source.
